(19) United States
(12) Patent Application Publication
(10) Pub. No.: US 2007/0090017 A1
(43) Pub. Date: Apr. 26, 2007

(54) THERMAL CRACKING HYDROCARBONACEOUS MATERIAL IN A MOLTEN METAL REACTOR

(76) Inventor: JAMES F. MAXWELL, Provo, UT (US)

Correspondence Address: JAMES SONNTAG;JAMES SONNTAG, PATENT ATTORNEY, P.O. BOX 9194, SALT LAKE CITY, UT, 84109, US

(21) Appl. No.: 11/552,650

(22) Filed: Oct. 25, 2006

Related U.S. Application Data
(60) Provisional application No. 60/730,258, filed on Oct. 26, 2005.

(51) Int. Cl. C10G 9/34; B01J 19/00

(52) U.S. Cl. 208/106; 422/129; 208/125; 422/198

(57) ABSTRACT

A system for recycling hydrocarbonaceous materials, such as motor oil, tires, and ores, into useful hydrocarbon distillates such as diesel fuel. A surface of a molten metal, such as lead, is used to volatilize the hydrocarbonaceous material and provide thermal-cracking conditions for the vapors produced. Thermally cracked vapors are then collected and recovered.

### CROSS REFERENCE TO RELATED APPLICATION

This application claims priority from U.S. Provisional Patent Application No. 60/730,258, filed 26 Oct. 2005.

### FEDERAL RESEARCH STATEMENT

(Not applicable)

### BACKGROUND OF INVENTION

Solid and liquid hydrocarbon wastes, such as old tires, plastic scrap, other waste materials, and spent lubricating fluids, such as used motor oil, present a continuing disposal and environmental problem. In response to this problem, processes have been developed to either recycle these wastes, or convert them to useful or environmentally safe products.

For motor oils, processes have been developed involving thermal cracking of the motor oils to form diesel fuel. In these processes, motor oil is thermally cracked in a batch or continuous systems. In continuous systems, motor oil is continuously fed through a coiled tube reactor that is heated to cracking temperatures in a furnace. Diesel fuel is then recovered from the cracked product. A problem with these processes is that the cracking produces carbon in the form of coke that builds up in the reactor coil. The buildup eventually leads to shut down of the process, and further operation requires removal of the coke. Because of the downtime and maintenance costs caused by the coke buildup, these processes are often not viable as a commercial process.

### SUMMARY OF INVENTION

The present invention is a process for thermally cracking hydrocarbonaceous wastes, such as old tires, plastic scrap, other wastes, and spent lubricating fluids, .such as used motor oil. In the present process the accumulation of carbon during thermal cracking is mitigated and the buildup will not cause a shut down. As the carbon is created it is removed from the reaction zone, and accordingly it cannot accumulate in the reactor.

This is accomplished by cracking vapors from the hyrdrocarbonaceous material over a surface of molten metal, such as lead. The carbon forms on the molten lead surface. The lead with the accumulated carbon floating on its surface is conveyed from the reaction zone to a separation zone, where the carbon is removed from the molten surface, and the molten metal with the carbon removed from its surface is then returned to the reaction zone. Thus, the carbon is continuously removed during the process, which prevents its buildup.

An aspect of the present invention is an apparatus for the thermal cracking of hydrocarbonaceous material. A molten metal surface in an oxygen-free atmosphere is provided by a containment containing molten metal; A reaction zone with a first zone and a second zone is provided. The first zone is on at least a portion of the molten metal surface. Upon this surface the hydrocarbonaceous materials are introduced. The temperature of the surface is sufficient to volatilize hydrocarbonaceous materials,

The second zone is over at least a portion of the metal surface and is where volatilized hydrocarbonaceous materials from the first zone are subjected to conditions sufficient for thermal cracking of the volatilized hydrocarbonaceous materials. The temperature in the second zone is maintained sufficient for thermal cracking by the heat from the underlying molten metal surface.

A conveyor is provided to convey the molten metal surface in a continuous recirculating pattern in the containment. A skimmer system is provided for removing carbon and other solid materials from the surface of the molten metal as the conveyor conveys the molten metal by the skimmer.

Another aspect is a method for thermal cracking hydrocarbonaceous material. The method involves the directing of the hydrocarbonaceous material onto a first zone on a surface of a molten metal where the temperature is sufficient to volatilize hydrocarbonaceous material. The volatilized hydrocarbonaceous materials from the first zone are heated to thermal-cracking temperatures in a second zone. In the second zone the volatilized hydrocarbonaceous materials are heated by the underlying molten metal surface; Vapors that have been subjected to the thermal-cracking temperatures are recovered. Carbon created by the thermal cracking and other solids are skimmed from the surface by conveying the molten metal in a continuously recirculating pattern past a skimming system that removes the carbon and the other solids.

### BRIEF DESCRIPTION OF DRAWINGS

FIG. 1 is a schematic top view of an exemplary apparatus.

FIG. 2 is a schematic side view of the apparatus of FIG. 1.

FIG. 3 is a schematic top view of another exemplary apparatus.

FIG. 4 is a schematic side view of the apparatus of FIG. 3.

FIG. 5 is a schematic of a portion the solid removal system of FIGS. 1 and 3.

### DETAILED DESCRIPTION

Referring to FIGS. 1, 2, 3, and 4, which are schematic diagrams showing exemplary reactors 101. A surface 103 of molten metal is created upon which hydrocarbonaceous materials are volatilized and over which the volatilized materials are thermally cracked. In the illustrated example, this is provided by a “lead table” which is a flat horizontal rectangular containment to contain a surface of molten lead 105, or other suitable molten metal. In this example the rectangular lead table 105 is constructed with a generally flat bottom 107 with a wall 109 along its periphery to provide a containment 111 for a shallow pool of liquid metal. A cover 113 is provided over the metal surface 103 to exclude oxygen from the atmosphere and provide a reaction zone 115 on and above the molten lead surface.

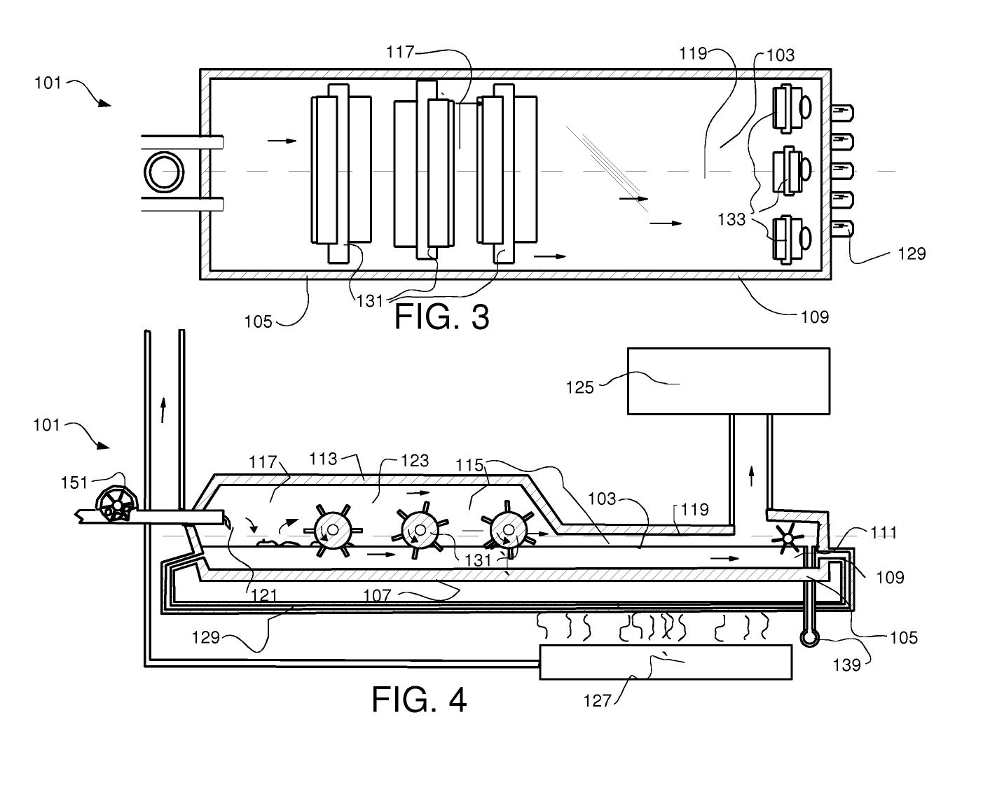

In a first zone 117 of the reaction zone, waste oil, or other hydrocarbonaceous material 121, is fed upon a portion of the molten metal surface. The feed structure 151 is designed to convey the hydrocarbonaceous material into the reactor without admitting atmospheric oxygen. For solid materials, the feed structure 151 can comprise any suitable structure, for example, a paddle mechanism (shown in partial cross-section in FIGS. 1 and 3). In addition, a solid material can be pretreated with flue gas, such as the effluents of combustion from the heater, to preheat the feed and to displace atmospheric oxygen in the feed. For liquids, a suitable pump, or the like can be used to convey the feed to the reaction zone.

As the material contacts the hot surface of the molten metal, volatile components of the material volatilize into vapor. In addition, solid and liquid materials may be broken down into materials that then become volatilized into vapor. The vapors collect in the space 123 above the lead surface and are drawn toward a second zone 119 where the vapors are subjected to thermal cracking conditions. The cover 113 over the second zone 119 is deliberately designed to direct the vapors down toward a region adjacent the hot surface of the molten metal where thermal cracking temperatures (e.g. temperatures greater than 700° F.) are achieved. In the illustration the clearance of the cover above the lead surface is accordingly reduced in the second zone.

From the second zone 119 the cracked vapors are drawn from the second zone under the cover to a suitable condenser system 125 to recover liquid products from the vapors. Optionally, vapors can removed at any point in the reactor to achieve a desired vapor density. The thermally cracked product from the second reaction zone includes hydrocarbons that can be components for diesel fuel, as well as other materials, such as gasses, hydrocarbons with too low or high of molecular weight for diesel fuel, and solids.

In a preferred embodiment of the invention, the thermally cracked product is treated to recover the diesel fuel components. This can be done by any suitable separation system, which can include one or more of flash, distillation, phase separation and any other suitable processes (not shown). For example, the gasses and low molecular weight components can be separated in a vapor stream and used to heat the lead bath, or sent to a flare tower. The high molecular weight components and solids may be separated as bottoms in the form of heavy oil (e.g. #6 fuel oil). The diesel oil components that are recovered can be used directly as a diesel fuel, or processed further or blended with other hydrocarbon materials.

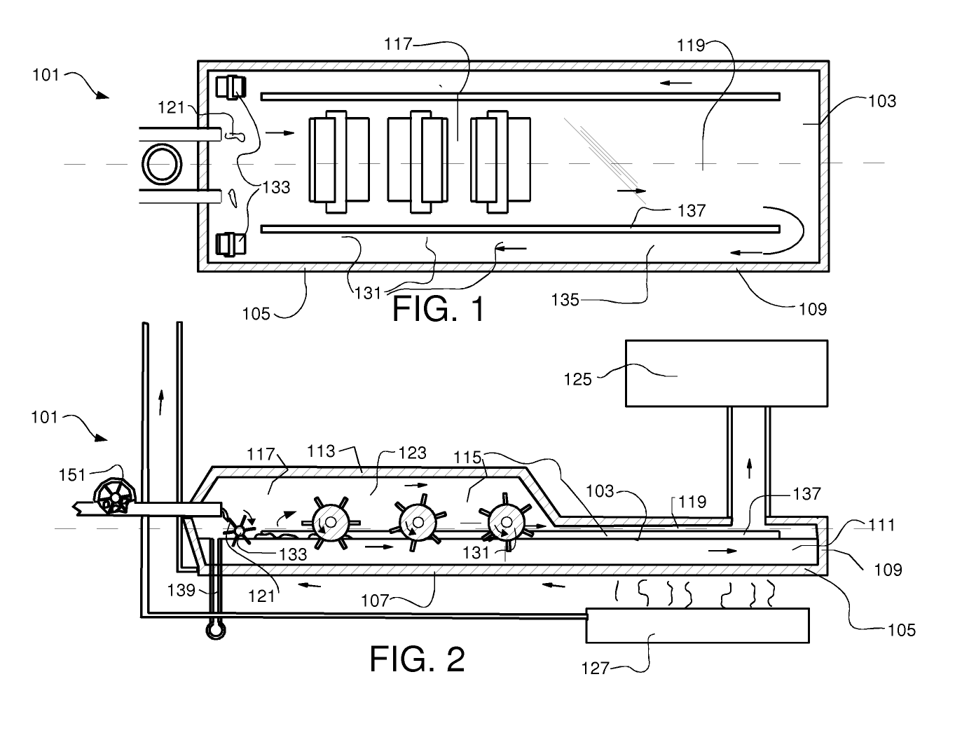

To maintain the liquid metal in a liquid state and to maintain the cracking temperatures at the second zone 119 a heater 127 is provided. In the example illustrated in FIG. 1 and FIG. 2, the heater 127 is disposed under the second zone to efficiently heat the liquid metal to provide the temperatures for thermal cracking in the second zone. Exhaust from the heater is directed (see arrows FIG. 2) under the containment 111 at the first zone 117 to maintain the lead in a liquid state and provide heat in the first zone to volatilize the motor oil.

In FIG. 3, and FIG. 4 is illustrated another example where the lead is circulated in pipes that run under the containment 111 and through the heater 127.

Referring again to FIGS. 1, 2, 3, and 4, the molten lead is continuously circulated by a series of paddles 131 in the first zone 117 that direct the molten metal toward the second zone 119. The cover 113 has a raised clearance there to accommodate the paddles 131.

The thermal cracking of the vapors deposits carbon upon the surface of the molten that by the movement of the molten are directed through the second zone. These accumulated carbon deposits, along with any other materials remaining after volatilization, are removed from the lead surface by skimming structures 133.

The motion of the paddles creates and recirculating pattern. Referring to FIG. 1, and FIG. 2, the molten metal with the accumulated carbon and other materials is directed back to the first zone 117 by conduits 135 or raceways provided on either side of the lead table by dikes 137, or the like. Referring to FIG. 3, and FIG. 4, the molten metal is directed by the first zone 117 through pipes 129 that draw lead from the region under the second zone, pass under the containment, and direct lead to the region of the first zone 117. In FIGS. 1 to 4, the paddles are shown with a large hub (e.g. 4 inch pipe) that is partially submerged in the molten lead. With this arrangement, hydrocarbonaceous material on the surface is drawn by the paddles under the surface in brought in greater contact with the hot lead.

The continuously circulating pattern created by the paddles brings the floating carbon and other materials upon the molten metal surface to the skimming structures 133, and floating materials are then removed by the skimming structures. In FIGS. 1 and 2, where the lead is circulated from the second zone back to the first zone by side conduits, the skimming structures 133 are placed at the ends of the conduits where the circulating molten metal enters the first zone. However, the skimmers may be placed at any suitable location in, after, or near the second zone where carbon and non-volatized materials can be removed. In FIGS. 3 and 4, where the molten metal is circulated from the second zone 119 back to the first zone 117 by the pipes passing under the containment and through the heater, the skimming structures are placed at the end of the second zone.

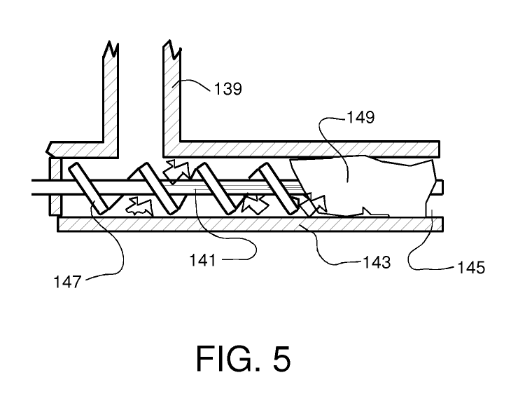

Referring to FIG. 5, which is a detail around the skimmer structure 133 in FIG. 1, the skimmer structure 133, which in the illustration comprises paddles, directs the solids into a vertical tube 139 that drops the solids to horizontal auger 141 turning in d close fitting horizontal tube 143. The auger 141 directs skimmed solids out through a tube exit 145 to a suitable disposal or processing unit (not shown). The flight 147 of the auger ends before the exit 145 (e.g., about 4 inches) so that in operation a plug 149 of the solid material is created at the exit, which provides seal from atmospheric oxygen.

By “molten metal” is meant any molten metal or material that can be heated molten to a suitable temperature to produce thermal cracking conditions, does not react sufficiently to materially interfere with the process, and function in process as described above. Any reference herein to molten lead, also contemplates any such suitable molten metal. The preferred molten metals are lead or lead-containing alloys. Other suitable molten materials include suitable metals, metal alloys, and salts that are molten at suitable temperatures for function of the apparatus.

The above example has been described as it applied to the processing of waste motor oil. It is contemplated by the invention that other hydrocarbonaceous sources could also be used in the process, where the hydrocarbon is volatilized into the vapor and cracked. This includes hydrocarbonaceous waste materials, such as tires, old asphalt pavement, municipal solid waste, or any byproducts from any of the above. The invention is also suitable for processing other hydrocarbonaceous materials. These include hydrocarbon-containing ores, such as oil shales and tar sands. Basically any material comprising hydrocarbonaceous substances that can be recovered by volatilizing upon the molten metal surface, as described, are contemplated. Where materials that contain a significant portion of nonvolatile materials, such as ores, pavement, or tires, are treated, the process and apparatus of the invention may be suitably modified to accommodate the increase in solid by-products, by, for example, increasing the capacity of the skimming systems. In addition, the size and configuration of the first zone and the second zone can be modified to accommodate the physical and chemical properties of the hydrocarbonaceous feed material.

It is also contemplated that the first zone and the second zone at least partially overlap or correspond in the sense that that thermal cracking of the vapors occurs over the same surface of the molten metal surface where volatilization of the hydrocarbonaceous feed occurs. The requirement is that the feed material becomes volatilized and the vapors therefrom are thermally cracked.

In the above description, circulating of the metal was by paddles, but the conveying can be by any suitable means, such as augers, screens, or the like with any construction that provides recirculation of the surface to allow continuous skimming of the solids. In addition, any such conveying system can be modified to accommodate the physical properties of the feed material.

While this invention has been described with reference to certain specific embodiments and examples, it will be recognized by those skilled in the art that many variations are possible without departing from the scope and spirit of this invention, and that the invention, as described by the claims, is intended to cover all changes and modifications of the invention which do not depart from the spirit of the invention.

What is claimed is:

1. An apparatus for thermal cracking of hydrocarbonaceous material comprising:
molten metal surface in an oxygen-free atmosphere provided by a containment containing molten metal;
a reaction zone comprising a first zone and a second zone the first zone on at least a portion of the molten metal surface upon which the hydrocarbonaceous materials are introduced and the temperature of the surface is sufficient to volatilize hydrocarbonaceous materials,
the second zone over at least a portion of the metal surface where volatilized hydrocarbonaceous materials from the first zone are subjected to conditions sufficient for thermal cracking of the volatilized hydrocarbonaceous materials, the temperature in the second zone maintained sufficient for thermal cracking by the underlying molten metal surface;
conveyor to convey the molten metal surface in a continuous recirculating pattern in the containment;
skimmer system for removing carbon and other solid materials from the surface of the molten metal as the conveyor conveys the molten metal by the skimmer.

2. An apparatus as in claim 1 wherein the molten metal is lead or a lead alloy.

3. An apparatus as in claim 1 wherein the hydrocarbonaceous material comprises waste motor oil.

4. An apparatus as in claim 1 wherein the hydrocarbonaceous material comprises oil shale.

5. An apparatus as in claim 1 wherein the hydrocarbonaceous material comprises tar sands.

6. An apparatus as in claim 1 wherein the hydrocarbonaceous material comprises solid waste.

7. An apparatus as in claim 1 wherein the hydrocarbonaceous material comprises tires.

8. An apparatus as in claim 1 wherein the surface portion upon which is the first zone, and the surface portion over which is the second zone at least partially overlap.

9. An apparatus as in claim 1 wherein the surface portion upon which is the first zone, and the surface portion over which is the second zone at least partially are on different portions of the molten metal surface.

10. An method for thermal cracking hydrocarbonaceous material comprising:
directing the hydrocarbonaceous material onto a first zone on a surface of a molten metal where the temperature is sufficient to volatilize hydrocarbonaceous material;
heating volatilized hydrocarbonaceous materials from the first zone to thermal-cracking temperatures in a second zone where the volatilized hydrocarbonaceous materials are heated by an underlying molten metal surface;
recovering vapors that have been subjected to the thermal-cracking temperatures;
skimming carbon created by the thermal cracking and solids from the surface by conveying the molten metal in a continuously recirculating pattern to convey the surface past a skimming system that removes the carbon and the other solids from the surface.
